(19) United States
(12) Patent Application Publication
(10) Pub. No.: US 2016/0099866 A1
(43) Pub. Date: Apr. 7, 2016

(54) PRIORITY DATA TRANSMISSION THROUGH REDUNDANT NETWORK

(71) Applicants: Allied Telesis Holdings Kabushiki Kaisha, Tokyo (JP); ALLIED TELESIS, INC., Bothell, WA (US)

(72) Inventor: Daniel Stellick, Geneva, IL (US)

(21) Appl. No.: 14/540,876

(22) Filed: Nov. 13, 2014

Related U.S. Application Data
(63) Continuation-in-part of application No. 14/504,252, filed on Oct. 1, 2014.

(51) Int. Cl. H04L 12/703; H04L 12/707

(52) U.S. Cl. CPC H04L 45/28; H04L 45/22

(57) ABSTRACT

A plurality of devices forms a communication network. The plurality of devices is networked via their respective primary link. The plurality of devices is configured to revert to a redundant network upon a primary link associated with a first device in the plurality of devices failing. A second device in the plurality of devices is configured to transmit a plurality of different types of data having different priorities to the first device through the primary link associated with the first device when the primary link associated with the first device is operational. The second device is further configured to reroute a subset of the plurality of different types of data based on the priorities of the plurality of different types of data through the redundant network in response to the primary link associated with the first device failing.

### CROSS-REFERENCE TO RELATED APPLICATION

This application is a continuation-in-part of U.S. patent application Ser. No. 14/504,252, filed Oct. 1, 2014.

### BACKGROUND

A network of connected devices typically communicates information through links established among each other. In some instances, links between devices and/or devices themselves may fail, which prevents some or all devices in the network from communicating information with each other and typically results in the loss of information. In data-sensitive applications, the loss of data is undesirable.

### SUMMARY

Accordingly, a need has arisen to reroute data through a redundant network in order to prevent loss of data in the event of a link and/or device failure. Moreover, a need has arisen to cache such data when a path to the device for which the data is intended does not exist so that the data may be later sent to the device when the link and/or device is functional again. Additionally, there is a need to reroute and/or cache higher priority type(s) of data when the redundant network does not have sufficient resources (e.g., bandwidth resources, storage resources, etc.) to reroute and/or cache all the data. In this manner, the higher priority type(s) of data may be secured when some data cannot be retained.

In some embodiments, a system includes a plurality of devices that forms a communication network. The plurality of devices may be networked via their respective primary link. The plurality of devices may be configured to revert to a redundant network upon a primary link associated with a first device in the plurality of devices failing. The system also includes a second device in the plurality of devices that may be configured to transmit a plurality of different types of data having different priorities to the first device through the primary link associated with the first device when the primary link associated with the first device is operational. The second device may be further configured to reroute a subset of the plurality of different types of data based on the priorities of the plurality of different types of data through the redundant network in response to the primary link associated with the first device failing.

In some embodiments, the second device may be further configured to determine an amount of available bandwidth in the redundant network for rerouting the plurality of different types of data to the first device. The second device may be further configured, in some embodiments, to determine the subset of the plurality of different types of data based on the determined amount of available bandwidth.

In some embodiments, the second device may determine the amount of available bandwidth based on bandwidth capabilities and bandwidth utilization of links in the redundant network. The second device may be further configured to reroute a different subset of the plurality of different types of data having higher priorities through the redundant network in response a change in the amount of available bandwidth in the redundant network.

It is appreciated that the primary link associated with the second device is associated with a first communication interface and the secondary link associated with the second device is associated with a second communication interface. It is further appreciate that the first communication interface differs from the second communication interface. In some embodiments the first communication interface is based on a wired link and the second communication interface is based on a wireless link. It is appreciated that the second communication interface is a radio frequency (RF) interface. It is also appreciated that the second communication interface is a Bluetooth interface.

In some embodiments, a system includes a plurality of devices that forms a communication network. The plurality of devices may be networked via their respective primary link. Devices in the plurality of devices may be configured to revert to a redundant network upon a primary link associated with a first device in the plurality of devices failing. The system also includes a second device in the plurality of devices that may be configured to send a plurality of different types of data having different priorities to the first device through the communication network. The second device may be further configured to cause a set of devices in the plurality of devices to cache a subset of the plurality of different types of data destined for the first device, based on the priorities of the plurality of different types of data, in response to the primary link associated with the first device failing and further in absence of an alternative path from the second device to the first device.

In some embodiments, the second device may be further configured to determine an amount of available storage in the communication network for caching the plurality of different types of data. The second device may be further configured to determine the subset of the plurality of different types of data destined for the first device based on the determined amount of available storage.

In some embodiments, the second device may determine the amount of available storage based on storage capabilities and storage utilization of devices in the plurality of devices. The second device may be further configured, in some embodiments, to dynamically change the set of devices based on changes in the amount of available storage in the communication network. In some embodiments, the second device may be further configured to cause at least one device in the set of devices to cache a type of data in the subset of the plurality of different types of data in place of a type of data having a lower priority.

In some embodiments, a system includes a plurality of devices that forms a communication network. The plurality of devices may be networked via their respective primary link. Devices in the plurality of devices may be configured to revert to a redundant network upon a primary link associated with a first device in the plurality of devices failing. The system further includes a second device in the plurality of devices configured to transmit a plurality of different types of data having different priorities to the first device through the primary link associated with the first device when the primary link associated with the first device is operational. The second device may be further configured to reroute a first subset of the plurality of different types of data based on priorities of the plurality of different types of data through a redundant link associated with the first device in response to the primary link associated with the first device failing and further in response to existence of a path from the first device to the second device. The second device may be further configured to cause a set of devices in the plurality of devices to cache a second subset of the plurality of different types of data destined for the first device, based on priorities of the plurality of different types of data, in response to the primary link associated with the first device failing and further in absence of the path from the second device to the first device.

In some embodiments, the second device may be further configured to cause the set of devices to transmit the cached data to the first device upon detecting that the primary link is functional again subsequent to the primary link associated with the first device failing. The second device may be further configured, in some embodiments, to use a plurality of different communication interfaces to reroute the first subset of the plurality of different types of data having higher priorities through the redundant network. It is appreciated that the plurality of different communication interfaces includes a wired interface and a wireless interface. It is also appreciated that the wireless interface is a radio frequency (RF) interface. It is further appreciated that wherein the wireless interface is a Bluetooth interface. In addition, it is appreciated that the wired interface is an Ethernet interface.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIGS. 1A-1H show examples of data rerouted through a redundant network in accordance with some embodiments.

FIGS. 2A-2C show examples of data cached by devices in a redundant network in accordance with some embodiments.

FIGS. 3A and 3B show a flow diagram for rerouting and caching data in a redundant network in accordance with some embodiments.

FIGS. 4A and 4B show a flow diagram for rerouting and caching data in a redundant network in accordance with some embodiments.

FIG. 5 shows a computer system in accordance with some embodiments.

FIG. 6 shows a block diagram of a computer system in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in an electronic device, a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “rerouting,” “caching,” “determining,” “sending,” “receiving,” “transmitting,” “dropping,” “determining,” “detecting,” “reverting,” “selecting” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of computer-executable instructions residing on some form of computer-readable storage medium, such as program modules, executed by one or more computers, computing devices, or other devices. By way of example, and not limitation, computer-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as computer-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of computer-readable storage media.

Embodiments described herein are directed to networks of devices that are configured to process higher priority type(s) of data, thereby preserving higher priority and more sensitive data. It is appreciated that processing of higher priority data type(s) may occur when a link/device fails and further when network resources (e.g., bandwidth resources, storage resources, etc.) are limited and/or constrained. In one exemplary embodiment, a sending device reroutes to a receiving device the highest priority type(s) of data through a redundant network based on available network resources (e.g., bandwidth resources). Accordingly, any number of the highest priority type(s) of data may be rerouted through the redundant network to the receiving device so long as the redundant network has sufficient resources to facilitate the rerouting of such data.

In some embodiments, when a path along a redundant network between a sending device and a receiving device does not exist, data intended for the receiving device is cached in the redundant network in order to prevent loss of such data. In some such embodiments, a sending device caches and/or directs other devices in the redundant network to cache data based on priorities of type(s) of data. In some embodiments, data is cached based on a ranked order of priority, e.g., the highest priority type of data cached first, a second highest priority type of data cached second, and so on and so forth. In some embodiments, data is cached in the redundant network based on available network resources (e.g., bandwidth resources, storage resources, etc.). As such, any number of the highest priority type(s) of data may be cached in the redundant network provided the redundant network has sufficient resources to cache the data.

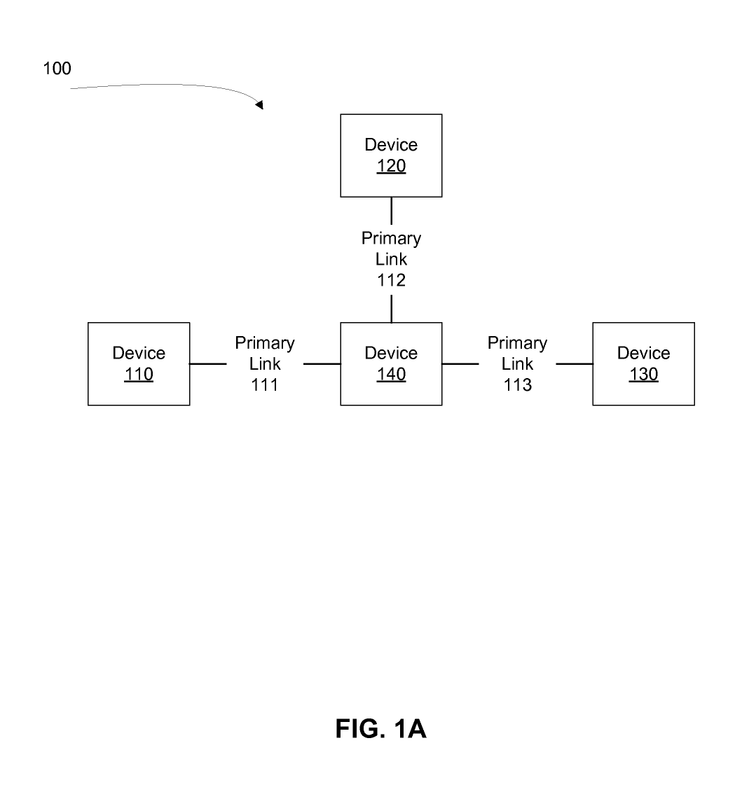

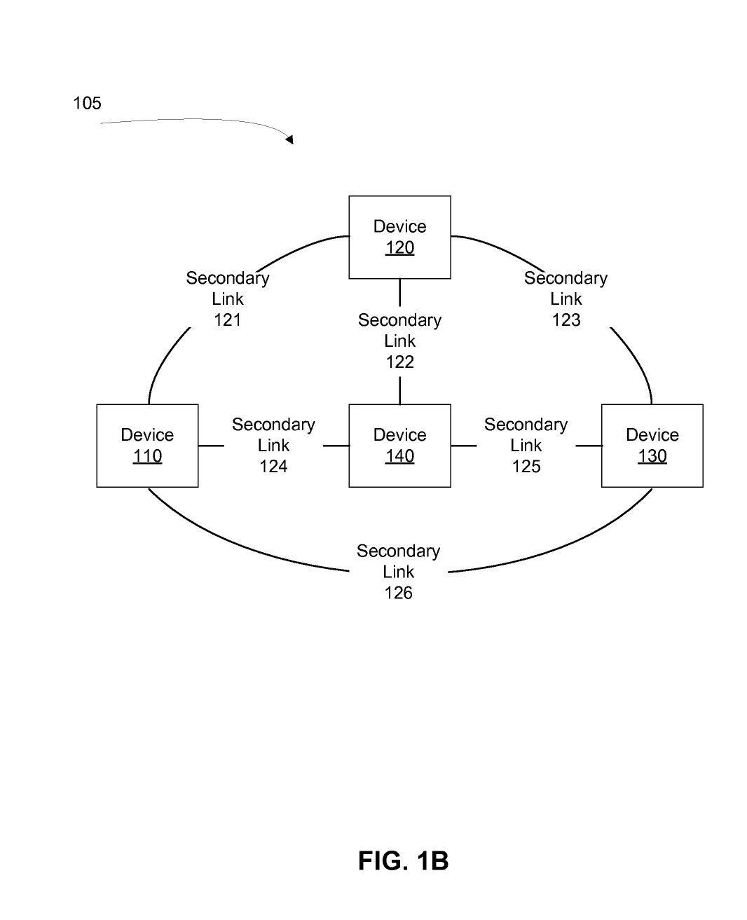

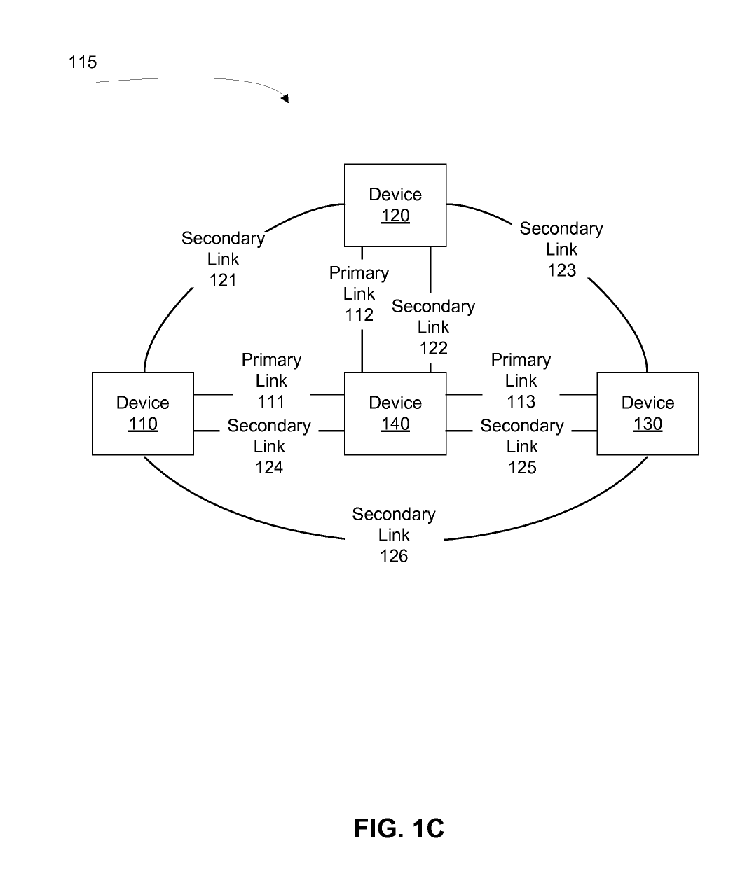

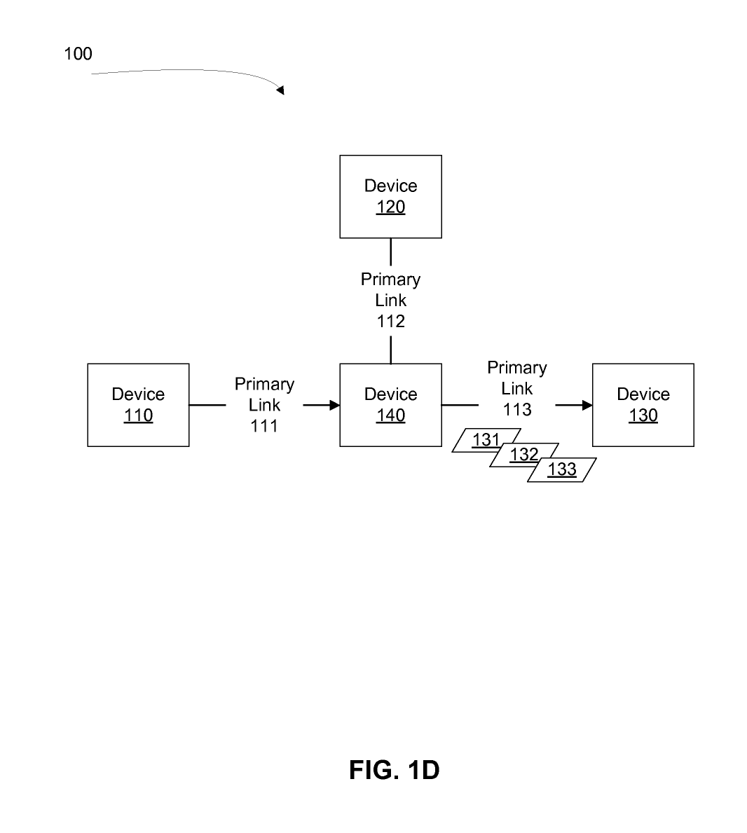

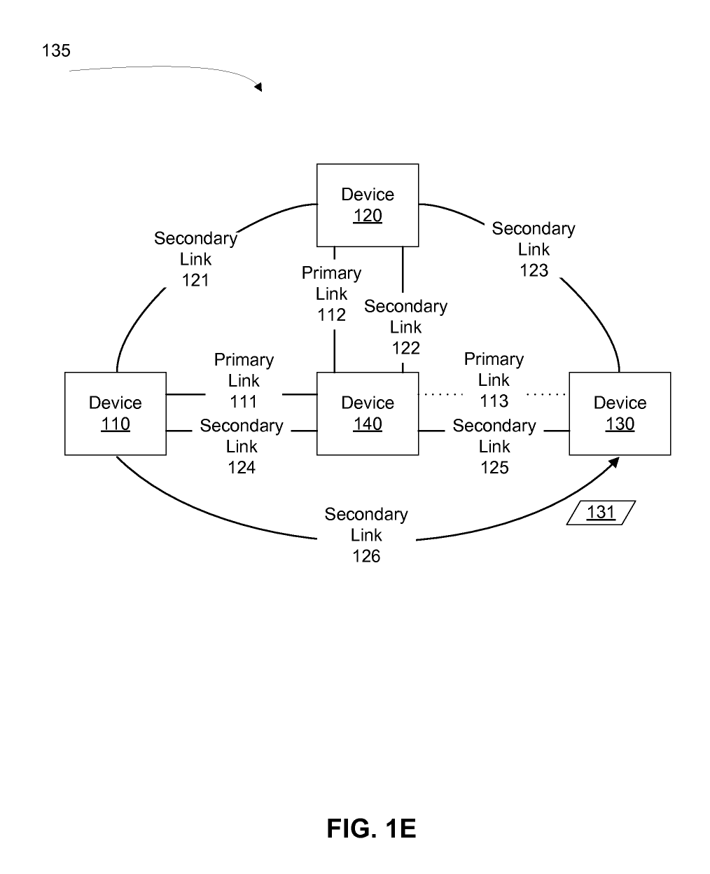

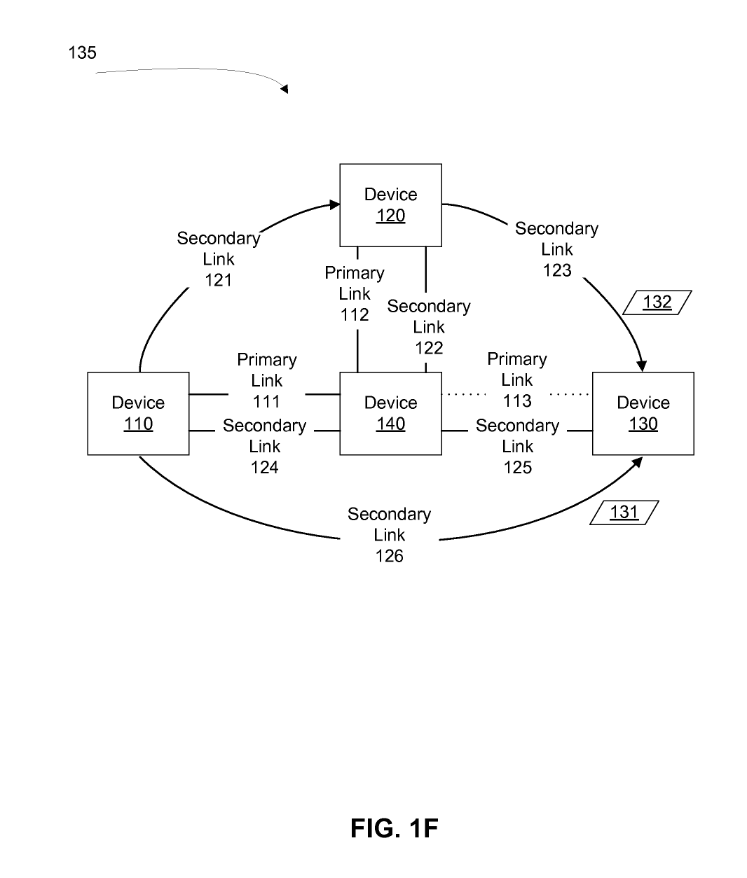

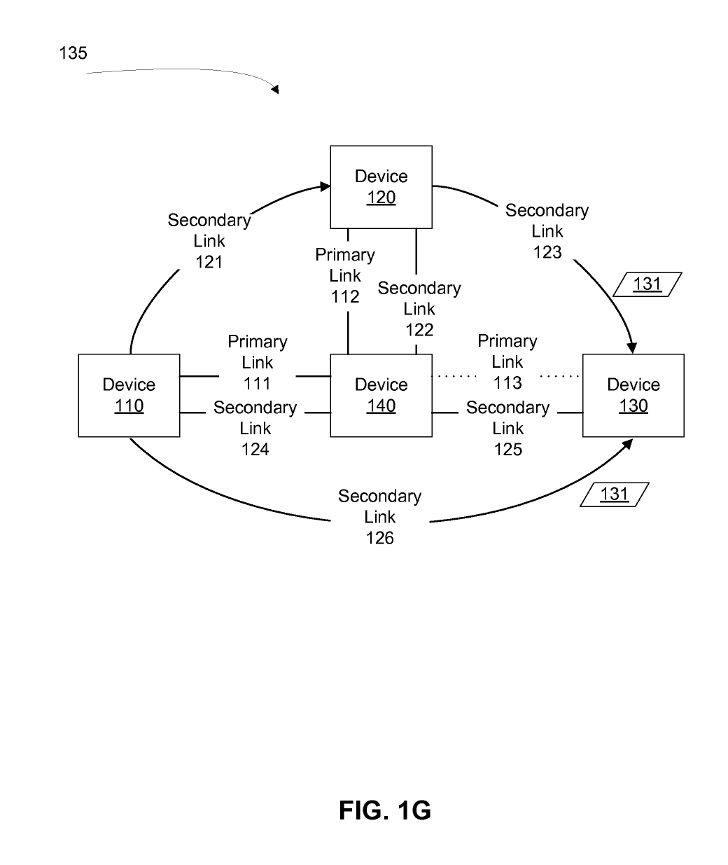

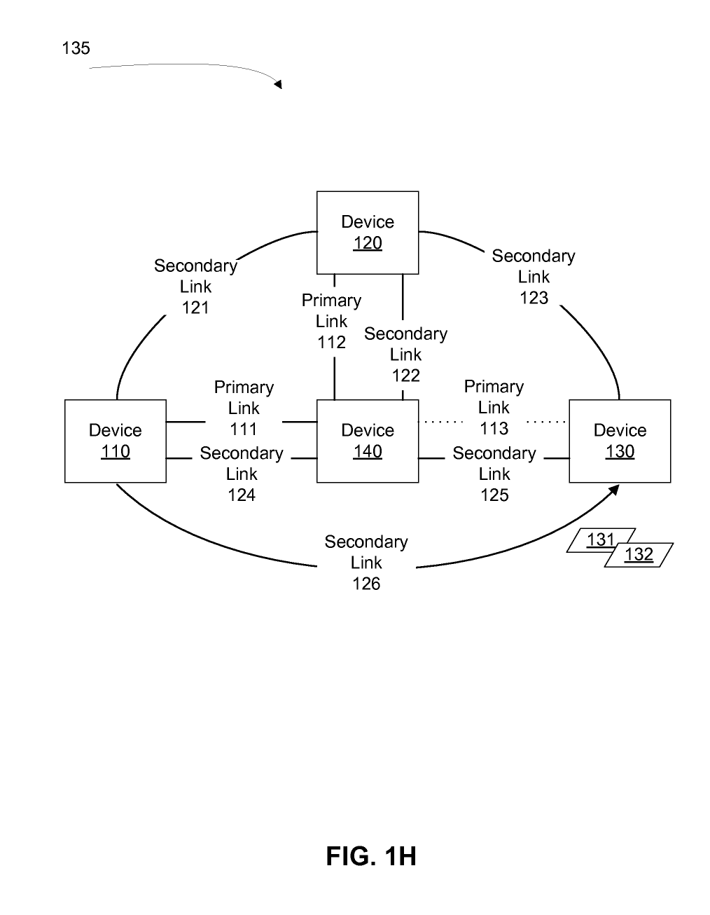

FIGS. 1A-1H show examples of data rerouted through a redundant network in accordance with some embodiments. Specifically, FIGS. 1A-1C illustrate an exemplary redundant network, FIGS. 1D-1F illustrate higher priority data being rerouted through a redundant network upon failure of a primary link, and FIGS. 1G and 1H illustrate higher priority data being rerouted through a redundant network while the primary link remains down. Referring now to FIG. 1A, a network 100 with primary links is shown in accordance with some embodiments. In this example, network 100 includes devices 110, 120, 130, and 140. As shown, primary link 111 couples device 110 with device 140, primary link 112 couples device 120 with device 140, and primary link 113 couples device 130 with device 140. In some embodiments, a primary link is a link coupling two devices through which the two devices use to communicate information with each other when the link is available (as opposed to other available links coupling the two devices).

Different embodiments use different methods and/or technologies for implementing primary links 111, 112, and 113 that couple devices 110, 120, 130, and 140. For instance, devices 110, 120, 130, and 140 each have a wired interface (e.g., an Ethernet interface) and primary links 111, 112, and 113 may be implemented via wired technologies (e.g., Ethernet technologies) associated with the wired interfaces in some embodiments.

It is appreciated that the devices described herein may be any type of device capable of being networked together (e.g., a sensor, an image capture device, a mobile device, a computer, a switch, a router, a hub, a bridge, etc.). In some embodiments, devices 110, 120, 130, and 140 may be the same or similar types of devices while, in other embodiments, some or all of devices 110, 120, 130, and 140 may be different types of devices. For example, each of devices 110, 120, and 130 may be a sensor (e.g., a chemical sensor, a biological sensor, a nuclear sensor, a radiological sensor, a temperature sensor, a pressure sensor, etc.) and device 140 may be a centralized computing device (e.g., a server computer) that receives (e.g., through primary links 111, 112, and 113), stores, analyzes, processes, etc., data captured by devices 110, 120, and 130. In such an example, devices 110, 120, 130, and 140, and primary links 111, 112, and 113, are arranged and function according to a star topology. It is appreciated that devices 110, 120, 130, and 140 may be arranged with primary links in any number of different topologies and/or arrangements in different embodiments.

Referring now to FIG. 1B, a network 105 with secondary links is shown in accordance with some embodiments. Specifically, network 105 illustrates secondary links coupling devices 110, 120, 130, and 140 shown in network 100 of FIG. 1A. As shown, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130. In some embodiments, a secondary link (also referred to as a redundant link in the present application) is a link coupling two devices through which the two devices use to communicate information with each other when a primary link coupling the two devices is unavailable (e.g., the primary link fails or degrades past a threshold level). Two devices may still use a secondary link coupling the two devices to communicate information with each other when a primary link coupling the two devices is still functional in some embodiments.

In addition, FIG. 1B illustrates an example of devices coupled to each other through secondary links according to a full mesh topology. In some embodiments, when devices are coupled using a full mesh topology, each device is coupled to every other device (i.e., a link is established between every different pair of devices). As shown in FIG. 1B, device 110 is coupled to devices 120, 130, and 140 through secondary links 121, 126, and 124; device 120 is coupled to devices 110, 130, and 140 through secondary links 121, 123, and 122; device 130 is coupled to devices 110, 120, and 140 through secondary links 126, 123, and 125; and device 140 is coupled to devices 110, 120, and 130 through secondary links 124, 122, and 125. It is appreciated that devices 110, 120, 130, and 140 may be arranged with secondary links in any number of different topologies (e.g., a partial mesh topology) and/or arrangements in different embodiments.

Different embodiments use different methods and/or technologies for implementing secondary links 121, 122, 123, 124, 125, and 126 that couple devices 110, 120, 130, and 140. For instance, in some embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11ax, Zigbee 802.15.4, Z-Wave ITU-T G.9959, RF etc.) and secondary links 121, 122, 123, 124, 125, and 126 are implemented using wireless technologies associated with the wireless interfaces. As another example, devices 110, 120, 130, and 140 may have another wired interface (e.g., a secondary Ethernet interface) and secondary links 121, 122, 123, 124, 125, and 126 are implemented using wired technologies associated with the wired interfaces.

Referring now to FIG. 1C, a network 115 with primary and secondary links is shown in accordance with some embodiments. In this example, network 115 includes devices 110, 120, 130, and 140. Moreover, devices 110, 120, 130, and 140 are coupled to each other by the primary links illustrated in FIG. 1A as well as the secondary links illustrated in FIG. 1B. That is, primary link 111 couples device 110 with device 140, primary link 112 couples device 120 with device 140, primary link 113 couples device 130 with device 140, secondary link 121 couples device 110 with device 120, secondary link 122 couples device 120 with device 140, secondary link 123 couples device 120 with device 130, secondary link 124 couples device 110 with device 140, secondary link 125 couples device 130 with device 140, and secondary link 126 couples device 110 with device 130.

Referring now to FIG. 1D, rerouting of different types of data through network 100 is shown in accordance with some embodiments. In this example, device 110 is sending to device 130 data 131 having a first data type, data 132 having a second data type, and data 133 having a third data type. It is appreciated that a type of data may be defined in any number of different ways. For instance, in some embodiments, a type of data may be defined based on the type of device (e.g., mobile device, network device, sensor, computer, server, etc.) from which the data is generated, the size (e.g., 1 kilobyte or less, greater than 1 kilobyte and less than 1 megabyte, 10 megabytes or greater, etc.) of the data, the sensitivity (e.g., private and/or personal data, public data, etc.) of the data, the age of the data (e.g., real-time data, data 1 minute or newer, data at least 1 hour old, etc.), the type of media (e.g., audio, video, still image, etc.) to which the data relates, the type of information (e.g., temperature information, humidity information, nuclear information, chemical information, etc.) to which the data relates, etc. As shown, device 110 is sending data 131, 132, and 133 to device 130 via primary links 111 and 113.

In some embodiments, a user may specify (e.g., through a graphical user interface (GUI)) different priorities for different types of data. Based on the specified priorities of the different types of data, devices may be configured to process data so the highest priority type(s) of data are secured when some of the data cannot be retained. In this example, data 131 is specified as having the highest priority, data 132 is specified as having the second highest priority, and data 133 is specified as having the third highest priority (i.e., the lowest priority in this example).

Referring to FIG. 1E, rerouting of high priority data via a path through redundant network 135 is shown in accordance with some embodiments. Specifically, FIG. 1E continues from the example described above by reference to FIG. 1D. For this example, a failure of primary link 113 in network 100 occurs and, subsequently, device 110 needs to send the three different types of data 131, 132, and 133 to device 130 (e.g., device 110 was sending the three different types of data 131, 132, and 133 via primary links 111 and 113 prior to the failure of primary link 113). The failure of primary link 113, as indicated by a dashed line, causes devices 110, 120, 130, and 140 to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11 ax, Zigbee 802.15.4, Z-Wave ITU-T G.9959, RF etc.) and secondary links 121, 122, 123, 124, 125, and 126 are implemented using wireless technologies associated with the wireless interfaces.

Once device 110 and/or device 140 detect that primary link 113 is no longer functioning (e.g., primary link 113 completely fails or degrades past a threshold level), device 110 and/or device 140 may determine an alternate path to transmit data between devices 110 and 130. For instance, device 110 may determine that at least one direct or indirect path to device 130 through redundant network 135 exists. Device 110 may then determine (e.g., via an application layer mechanism) an amount of available bandwidth through redundant network 135 to device 130. In some embodiments, device 110 determines the amount of available bandwidth based on the bandwidth capabilities and bandwidth utilization of primary and secondary links along paths to device 130. After determining the available bandwidth, device 110 determines the highest priority type(s) of data that may be transmitted to device 130 based on the determined available bandwidth. It is appreciated that, in some embodiments, device 140 may determine the amount of available bandwidth and determine the highest priority type(s) of data that may be transmitted to device 130.

In this example, device 110 determines that redundant network 135 has sufficient available bandwidth to transmit data 131, the highest priority type of data, to device 130. In particular, device 110 determines that secondary link 126 has available bandwidth for transmitting data 131 to device 130 (e.g., the bandwidth of primary links 111 and 112, and secondary links 121, 122, 123, 124, and 125 are being utilized for other purposes and/or higher priority types of data). As a result, device 110 reroutes data 131 to device 130 via secondary link 126 and drops data 132 and 133 (not shown).

Referring to FIG. 1F, rerouting of high priority data via several paths through redundant network 135 is shown in accordance with some embodiments. This example is similar to the example described above by reference to FIG. 1E in that a failure of primary link 113 in network 100 of FIG. 1D occurs and, subsequently, device 110 needs to send the three different types of data 131, 132, and 133 to device 130 (e.g., device 110 was sending the three different types of data 131, 132, and 133 to device 130 via primary links 111 and 113 prior to the failure of primary link 113). In addition, the failure of primary link 113 causes devices 110, 120, 130, and 140 to revert to redundant network 135. In some embodiments, redundant network 135 includes functioning primary links and a secondary link that corresponds to each non-functioning primary link. As another example, redundant network 135 may include secondary links that couple each device to every other device. For this example, redundant network 135 includes primary links 111 and 112, and secondary links 121, 122, 123, 124, 125, and 126. It is appreciated that redundant network 135 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11 ax, Zigbee 802.15.4, Z-Wave ITU-T G.9959, RF etc.) and secondary links 121, 122, 123, 124, 125, and 126 are implemented using wireless technologies associated with the wireless interfaces.

When device 110 and/or device 140 detect that primary link 113 is no longer functioning (e.g., primary link 113 completely fails or degrades past a threshold level), device 110 and/or device 140 may determine an alternate path to transmit data between devices 110 and 130. For example, device 110 may determine that at least one direct or indirect path to device 130 through redundant network 135 exists. Device 110 may then determine (e.g., via an application layer mechanism) an amount of available bandwidth through redundant network 135 to device 130. As mentioned above, device 110 determines the amount of available bandwidth based on the bandwidth capabilities and bandwidth utilization of primary and secondary links along paths to device 130, in some embodiments. Upon determining the available bandwidth, device 110 determines the highest priority type(s) of data that may be transmitted to device 130 based on the determined available bandwidth. It is appreciated that device 140 may determine the amount of available bandwidth and determine the highest priority type(s) of data that may be transmitted to device 130, in some embodiments.

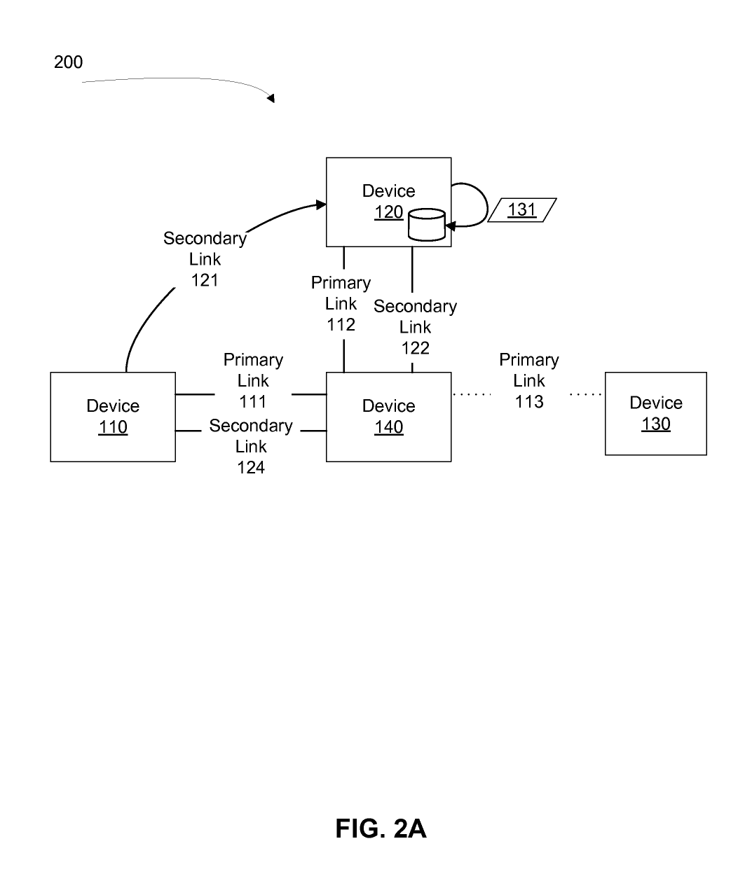

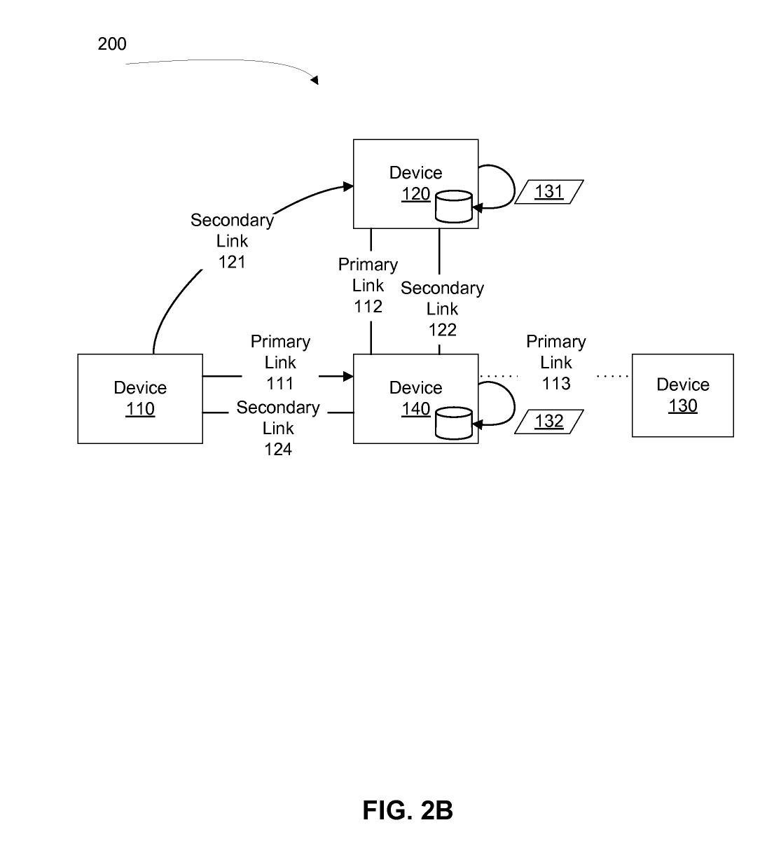

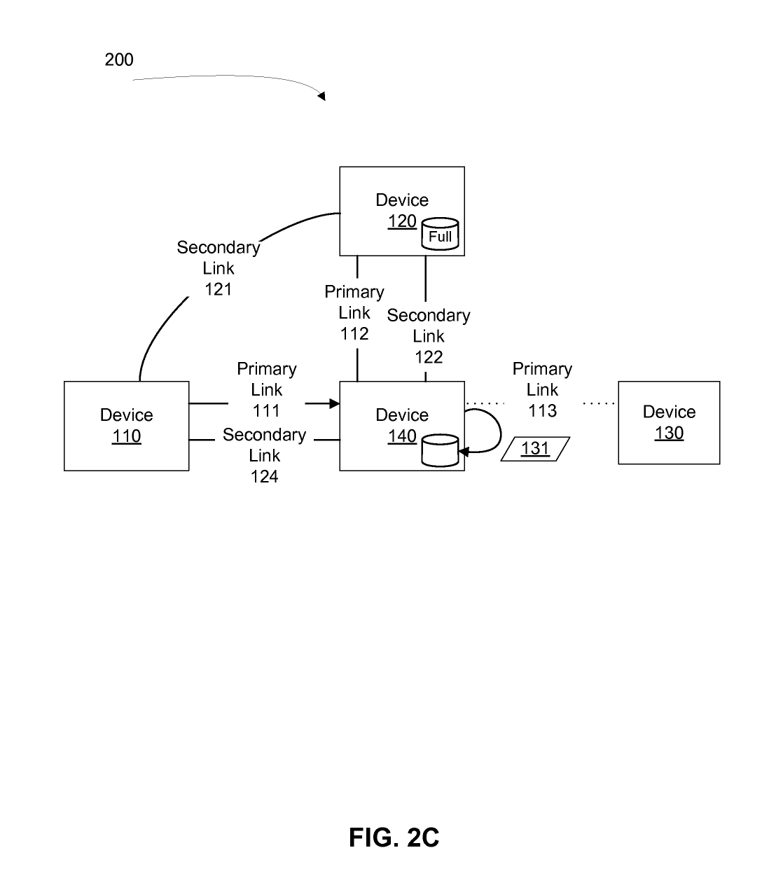

For this example, device 110 determines that redundant network 135 has sufficient available bandwidth to transmit data 131 and 132, the highest and second highest priority types of data, to device 130. Specifically, device 110 determines that secondary link 126 has available bandwidth for transmitting data 131 to device 130 and secondary links 121 and 123 have available bandwidth for transmitting data 132 to device 130. As shown, device 110 reroutes data 131 to device 130 via secondary link 126, and reroutes data 132 to device 130 via secondary links 121 and 123. Device 110 drops data 133 (not shown). In some embodiments, device 110 caches data 133 in redundant network 135 in the same or similar manner as that described below by reference to FIGS. 2A-2C.

In some embodiments, the amount of available bandwidth for rerouting data through a redundant network may fluctuate. Such fluctuations may allow devices in the redundant network to transmit additional higher priority type(s) of data (e.g., when available bandwidth increases) and/or may cause devices in the redundant network to drop (and/or cache) lower priority type(s) of data (e.g., when available bandwidth decreases).

Referring now to FIG. 1G, dropping of high priority data when available bandwidth in redundant network 135 decreases is shown in accordance with some embodiments. In particular, FIG. 1G continues from the example described above by reference to FIG. 1F. In this example, device 110 determines (e.g., via an application layer mechanism) that secondary link 126 no longer has sufficient bandwidth for device 110 to send data 131 to device 130 (e.g., the bandwidth through secondary link 126 is being utilized for type(s) of data having higher priority than data 131). In addition, device 110 determines that the path from device 110 to device 130 via secondary link 126 together with the path from device 110 to device 130 via secondary links 121 and 123 have sufficient available bandwidth to send data 131 to device 130 provided that device 110 no longer uses the path via secondary links 121 and 123 to transmit data 132 to device 130. It is appreciated that device 140 may make such a determination. Since data 131 has a higher priority than data 132, device 110 stops sending data 132 to device 130 and drops data 132. In some embodiments, device 110 caches data 132 in redundant network 135 in the same or similar manner as that described below by reference to FIGS. 2A-2C. As illustrated in FIG. 1G, device 110 instead reroutes data 131 to device 130 through a path via secondary link 126 and another path via secondary links 121 and 123.

Referring now to FIG. 1H, transmission of additional high priority data when available bandwidth in redundant network 135 increases is shown in accordance with some embodiments. Specifically, FIG. 1H continues from the example described above by reference to FIG. 1E. For this example, device 110 determines (e.g., via an application layer mechanism) that secondary link 126 has additional available bandwidth for device 110 to send data 131 and 132 to device 130 (e.g., utilization of the bandwidth of secondary link 126 decreased, the bandwidth of secondary link 126 is being utilized for type(s) of data having lower priority than data 132). It is appreciated that device 140 may make such a determination. As shown in FIG. 1H, device 110 reroutes data 131 and 132 to device 130 through a path via secondary link 126.

The above-described FIGS. 1E-1H illustrate one device rerouting the highest priority type(s) of data to another device in a redundant network. It is appreciated that one device may reroute the highest priority data type(s) of data to several different devices in a redundant network. Referring to FIG. 1F as an example, data 132 may be intended for device 120. In such an example, device 110 may reroute data 132 to device 120 via secondary link 121 and reroute data 131 to device 130.

The figures described above illustrate examples and/or embodiments of rerouting higher priority type(s) of data from one device to another device when a path through the redundant network exists between the devices. In some embodiments, when a path between one device and another device does not exist, higher priority type(s) of data intended for the other device may be cached in order to prevent loss of such data. FIGS. 2A-2C show examples of data cached by devices in a redundant network in accordance with some embodiments. Referring now to FIG. 2A, caching of high priority data by a device in a redundant network 200 is shown in accordance with some embodiments. In particular, FIG. 2A continues from the example described above by reference to FIG. 1D. For this example, a failure of primary link 113 in network 100 occurs and, subsequently, device 110 needs to send the three different types of data 131, 132, and 133 to device 130 (e.g., device 110 was sending the three different types of data 131, 132, and 133 to device 130 via primary links 111 and 113 prior to the failure of primary link 113). The failure of primary link 113, as indicated by a dashed line, causes devices 110, 120, 130, and 140 to revert to redundant network 200. In some embodiments, redundant network 200 includes functioning primary links and a secondary link that corresponds to each non-functioning primary link. As another example, redundant network 200 may include secondary links that couple each device to every other device. For this example, redundant network 200 includes primary links 111 and 112, and secondary links 121, 122, and 124. It is appreciated that redundant network 200 may include any combination of primary and/or secondary links to establish a redundant path between any two devices. As mentioned above, in some embodiments, devices 110, 120, 130, and 140 each have a wired interface (e.g., an Ethernet interface) and primary links 111 and 112 may be implemented via wired technologies (e.g., Ethernet technologies) associated with the wired interfaces. In some such embodiments, devices 110, 120, 130, and 140 have the same type of, or a compatible, wireless interface (e.g., Wi-Fi, Bluetooth, Ultra Wide Band (UWB) 802.15.3a, 802.11af/White-Fi, 802.11 ax, Zigbee 802.15.4, Z-Wave ITU-T G.9959, RF etc.) and secondary links 121, 122, and 124 are implemented using wireless technologies associated with the wireless interfaces.

When device 110 and/or device 140 detect that primary link 113 is no longer functioning (e.g., primary link 113 completely fails or degrades past a threshold level), device 110 and/or device 140 may determine that a path to device 130 through redundant network 200 does not exist. Device 110 may then determine (e.g., via an application layer mechanism) an amount of available storage in redundant network 200. In some embodiments, device 110 determines the amount of available storage based on the storage capabilities and storage utilization of devices 120 and 140 as well as itself. After determining the available storage, device 110 determines the highest priority type(s) of data that may be cached in redundant network 200 based on the determined available storage. It is appreciated that, in some embodiments, device 140 may determine the amount of available storage in redundant network 200 and determine the highest priority type(s) of data that may be cached in redundant network 200.

For this example, device 110 determined that redundant network 200 has sufficient available storage to cache data 131, the highest priority type of data. Specifically, device 110 determined that device 120 has available storage for caching data 131 (e.g., devices 110 and 140 are at or near a maximum or threshold capacity level). As a result, device 110 sends data 131 to device 120 via secondary link 121 and directs device 120 to cache data 131, as illustrated in FIG. 2A. Additionally, device 110 drops data 132 and 133 (not shown). Device 110 continues to send data 131 to device 120 to cache while primary link 113 is not functional. When device 110 and/or device 140 detect that primary link 113 is functional while device 120 is caching data 131, device 110 may stop sending data 131 to device 120 and instead send data 131 (along with data 132 and 133) to device 130 (e.g., via primary links 111 and 113). Additionally, device 110 may direct device 120 to send data 131 that it has cached to device 130 (e.g., via primary links 112 and 113).

In some embodiments, the amount of available storage for caching data in a redundant network may fluctuate. These fluctuations may allow devices in the redundant network to cache additional higher priority type(s) of data (e.g., when available storage increases) and/or may cause devices in the redundant network to drop lower priority type(s) of data (e.g., when available storage decreases).

Referring now to FIG. 2B, caching of additional high priority data when available storage in redundant network 200 increases is shown in accordance with some embodiments. In particular, FIG. 2B continues from the example described above by reference to FIG. 2A. In this example, device 110 determines that redundant network 200 has sufficient available storage to cache data 131 and 132, the highest and second highest priority types of data. Specifically, device 110 determines (e.g., via an application layer mechanism) that device 120 still has available storage for caching data 131 and that device 140 now has available storage for caching data 132. It is appreciated that device 140 may determine the amount of available storage in redundant network 200, in some embodiments. As a result, device 110 directs device 120 to continue caching data 131 and directs device 140 to cache data 132. As illustrated in FIG. 2B, device 110 sends data 131 to device 120 via secondary link 121 for device 120 to cache and sends data 132 to device 140 via primary link 111 for device 140 to cache.

While primary link 113 is not functional, device 110 continues to send data 131 to device 120 to cache and data 132 to device 140 to cache. Upon device 110 and/or device 140 detecting that primary link 113 is functional while devices 120 and 140 are caching data 131 and 132, respectively, device 110 may stop sending data 131 to device 120 and data 132 to device 140 for caching. Device 110 may instead send data 131 and 132 (along with data 133) to device 140 for forwarding to device 130 via primary links 111 and 113. In addition, device 110 may direct device 120 to send data 131 that it has cached to device 130 (e.g., via primary links 112 and 113) and device 140 to send data 132 that it has cached to device 130 (e.g., via primary link 113).

FIG. 2B illustrates one device directing different devices to cache different types of data. In some cases, one device may direct another device to cache the different types of data. For example, device 110 may direct device 120 to cache data 131 and 132 (provided device 110 determined that device 120 has sufficient available storage to cache data 131 and 132). In other cases, one device may direct different devices to cache the same or similar type of data. For instance, device 110 may direct device 120 to cache a portion of data 131 and device 140 to cache the remaining portion of data 131 (provided device 110 determined that device 140 has sufficient available storage to cache the remaining portion of data 131 and data 132). It is appreciated that one device may direct any number of devices (including itself) to cache the same and/or different types of data. Referring to FIG. 1F as an example, data 132 may be intended for device 120. In such an example, device 110 may reroute data 132 to device 120 via secondary link 121 and reroute data 131 to device 130.

Referring now to FIG. 2C, dropping of high priority data when available storage in redundant network 200 decreases is shown in accordance with some embodiments. Specifically, FIG. 2C continues from the example described above by reference to FIG. 2B. For this example, device 110 determines that redundant network 200 has sufficient available storage to cache data 131, the highest priority type of data. In particular, device 110 determines (e.g., via an application layer mechanism) that device 120 no longer has available storage for caching data 131, as indicated by a “Full” label on the storage of device 120, and that device 140 has available storage for caching data 131. It is appreciated that, in some embodiments, device 140 may determine the amount of available storage in redundant network 200. As a result, device 110 stops sending data 131 to device 120 and data 132 to device 140. Instead, device 110 sends data 131 to device 140 via primary link 111 and directs device 140 to cache data 131, as illustrated in FIG. 2C.

Device 110 continues to send data 131 to device 140 to cache while primary link 113 is not functional. When device 110 and/or device 140 detects that primary link 113 is functional while device 140 is caching data 131, device 110 may stop sending data 131 to device 140 for caching and instead send data 131 (along with data 132 and 133) to device 140 for forwarding to device 130 via primary links 111 and 113. In addition, device 110 may direct device 120 to send data 131 that it has cached to device 130 (e.g., via primary links 112 and 113).

FIGS. 2A-2C show storages used for caching data as part of devices. It is appreciated that such storages may be external to the devices. For example, the devices may cache the data in external hard disk drives, flash drives, solid state drives, a server, a cloud computing service etc., in some embodiments.

In addition, FIGS. 2A-2C illustrate device 110 sending data to other devices in redundant network 200 along a particular path through redundant network 200. It is appreciated that device 110 may send the data along any number of different and/or additional paths. Referring back to FIG. 2A as an example, device 110 may send data to device 120 along a path through redundant network 200 via primary links 111 and 112 in addition to, or in lieu of, the shown path via secondary link 121.

FIGS. 2A-2C also describe a device determining type(s) of data to cache based on available storage in a redundant network. In some embodiments, a device may determine to cache higher priority type(s) of data based on available storage in a redundant network as well as storage used by lower priority type(s) of data. In some such embodiments, the device may cache higher priority type(s) of data in available storage and/or storage used by lower priority type(s) of data (e.g., by overwriting storage used by lower priority type(s) of date) in the redundant network.

It is appreciated that, in some embodiments, determining the highest priority type(s) of data that may be cached in a redundant network may be further based on any number of different factors. For example, determining the highest priority type(s) of data for caching in a redundant network may be based on available storage in the redundant network as well as available bandwidth in the redundant network. Referring to FIG. 2B as an example, device 110 may determine that primary link 111 and secondary link 124 do not have sufficient bandwidth to transmit data 132 to device 140. In such an example, device 110 determines to cache data 131 (e.g., by sending data 131 to device 120 via secondary link 121) and drop data 132 and 133.

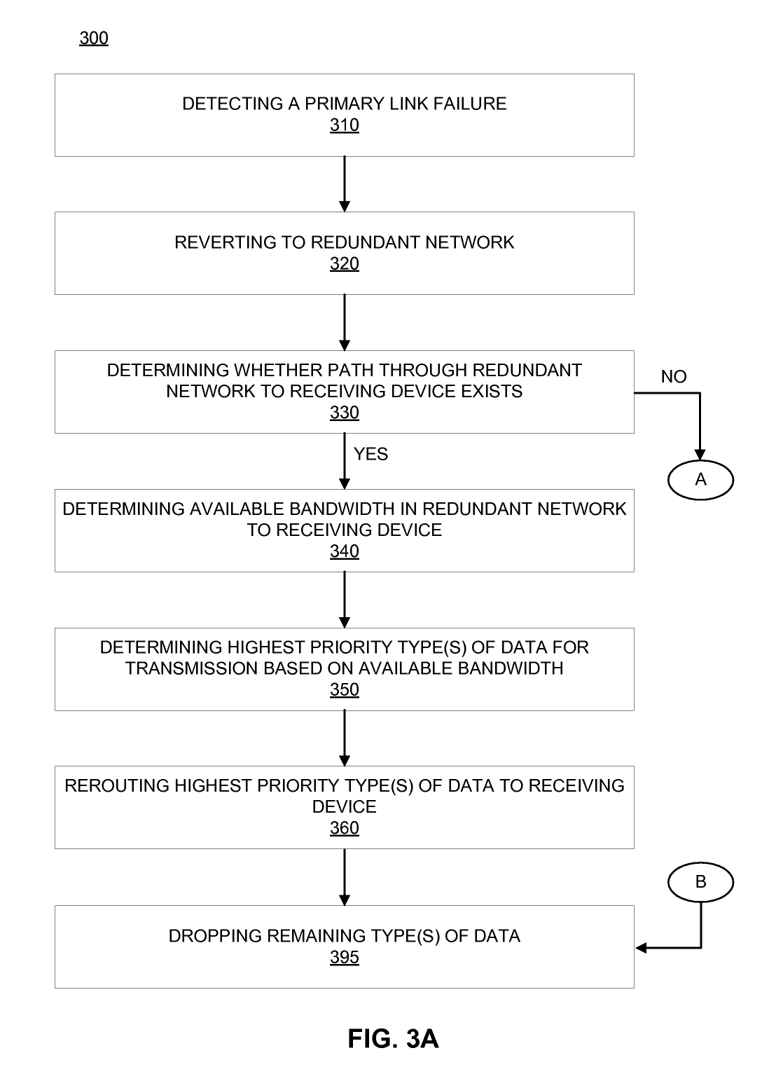

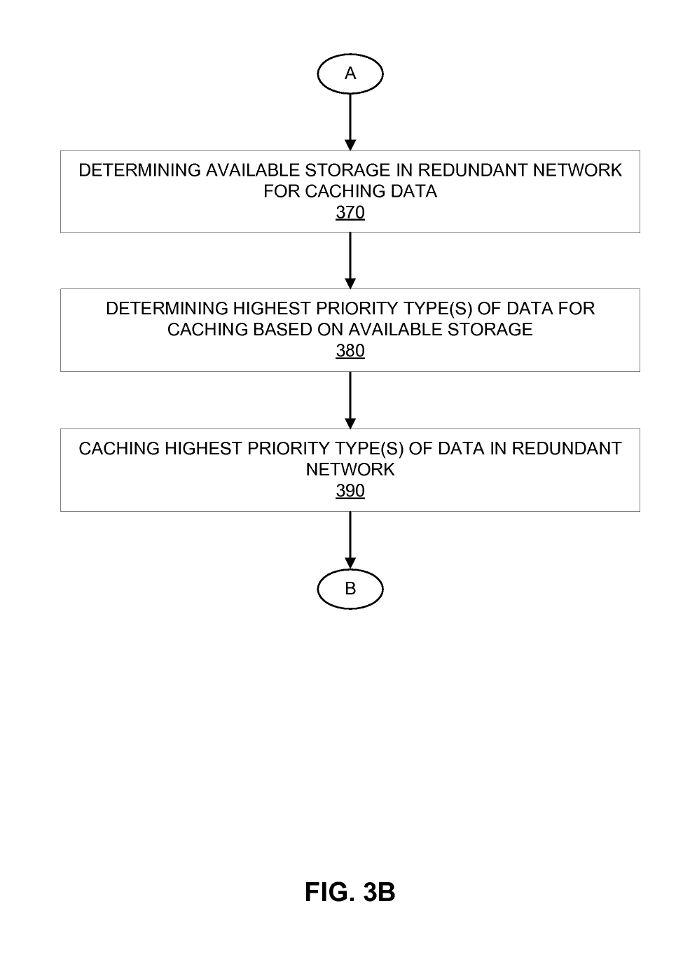

FIGS. 3A and 3B show a flow diagram for rerouting and caching data in a redundant network in accordance with some embodiments. In some embodiments, a device (e.g., device 110 and/or device 140 described above by reference to FIGS. 1E-1H) sending data to another device performs the operations described in FIGS. 3A and 3B. At step 310 shown in FIG. 3A, a primary link failure is detected. In some embodiments, the primary link failure is detected while sending data to a receiving device. In some embodiments, a primary link failure is detected when the primary link no longer functions or degrades past a threshold level. Referring to FIG. 1E as an example, device 110 detects failure of primary link 113 while sending data to device 130.

At step 320, reversion to a redundant network occurs. Referring to FIG. 1D as an example, when primary link 113 fails, device 110 (along with devices 120, 130, and 140) revert to redundant network 135 with primary links 111 and 112, and secondary links 121, 122, 123, 124, 125, and 126. After reverting to the redundant network, at step 330, it is determined whether a path to through the redundant network to the receiving device exists.

If a path through the redundant network to the receiving devices is determined to exist, at step 340, available bandwidth in the redundant network to the receiving device is determined. In some embodiments, the amount of available bandwidth is determined based on the bandwidth capabilities and bandwidth utilization of primary and secondary links along paths to the receiving device. At step 350, the highest priority type(s) of data for transmission is determined based on the available bandwidth. In some embodiments, the different types of data are ranked in order of priority, e.g., the highest priority type of data is ranked as first, a second highest priority type of data is ranked as second, and so on and so forth, and, based on the available bandwidth, a number of top-ranking types of data is determined for rerouting. As explained above, a user may specify (e.g., through a GUI) different priorities for different types of data so that the highest priority type(s) of data are secured when some data cannot be retained. The highest priority type(s) of data are sent to the receiving device at step 360 and remaining type(s) of data are dropped at step 395.

If a path through the redundant network to the receiving devices is determined to not exist, at step 370 illustrated in FIG. 3B, available storage in the redundant network for caching data is determined. The amount of available storage in the redundant network is determined, in some embodiments, based on the storage capabilities and storage utilization of devices in the redundant network. At step 380, the highest priority type(s) of data for caching are determined based on the available storage. As mentioned above, such a determination may be based on any number of different factors (e.g., available bandwidth in the redundant network). The highest priority type(s) of data are cached in the redundant network at step 390 and remaining type(s) of data are dropped at step 395 shown in FIG. 3A.

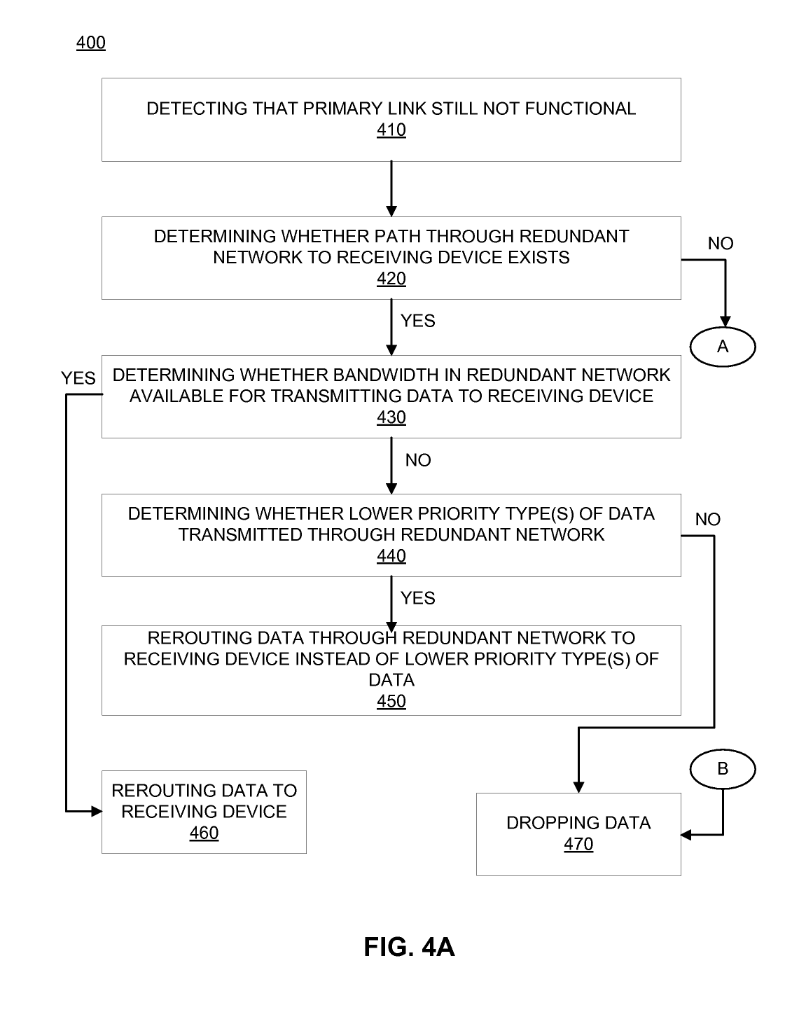

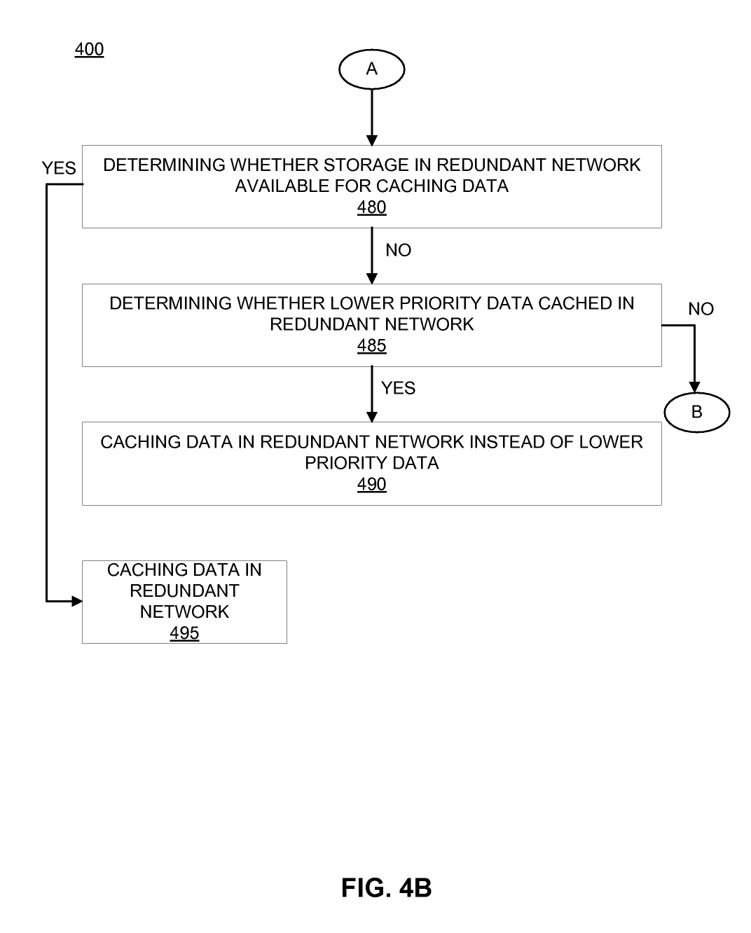

FIGS. 4A and 4B show a flow diagram for rerouting and caching data in a redundant network in accordance with some embodiments. In some embodiments, a device (e.g., device 110 and/or device 140 described above by reference to FIGS. 2A-2C) that generates data destined for another device after a primary link failure has occurred, performs the operations described in FIGS. 4A and 4B. At step 410, a primary link failure is detected as still not functional (e.g., the primary link remains completely failed or degraded past a threshold level).

At step 420, it is determined whether a path through a redundant network to a receiving device exists. If a path through the redundant network to the receiving device is determined to exist, it is determined, at step 430, whether bandwidth in the redundant network is available for transmitting data to the receiving device. When bandwidth in the redundant network is available for transmitting data to the receiving device, the data is rerouted to the receiving device at step 460.

If bandwidth in the redundant network is not available for transmitting data to the receiving device, it is determined, at step 440, whether lower priority type(s) of data are being transmitted (e.g., for rerouting or for caching) through the redundant network. When lower priority type(s) of data are being transmitted through the redundant network, the data is rerouted to the receiving device through the redundant network instead of some or all of the lower priority type(s) of data. In some embodiments, the lower priority type(s) of data that are no longer transmitted are dropped. If lower priority type(s) of data are not being transmitted through the redundant network, the data is dropped at step 470.

If a path through the redundant network to the receiving device is determined to not exist, it is determined, at step 480, whether storage in the redundant network is available for caching data. If storage in the redundant network is determined to be available for caching data, the data is cached, at step 495 in the redundant network. It is appreciated that one or more devices in the redundant network may cache the data for later transmission to the receiving device.

When storage in the redundant network is not available for caching data, it is determined, at step 485, whether lower priority data are cached in the redundant network. If lower priority data are cached in the redundant network, the data is cached in the redundant network instead of some or all of the lower priority type(s) of data at step 490. The lower priority type(s) of data that are replaced by the data are dropped. In some embodiments, data having lower priority type(s) of data are dropped by deleting such type(s) of data from the device(s) in the redundant network on which the type(s) of data are cached. When lower priority type(s) of data are not cached in the redundant network, the data is dropped at step 470, as shown in FIG. 4A.

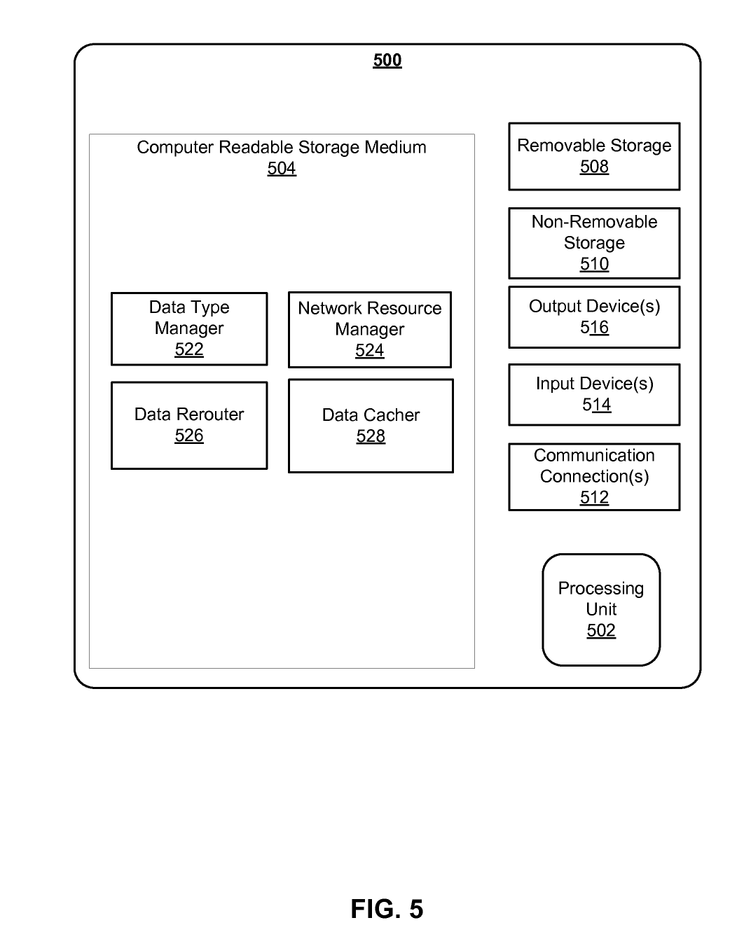

Referring now to FIG. 5, a block diagram of a computer system in accordance with some embodiments is shown. With reference to FIG. 5, an exemplary system module for implementing embodiments includes a general purpose computing system environment, such as computing system environment 500. Computing system environment 500 may include, but is not limited to, servers, switches, routers, desktop computers, laptops, tablets, mobile devices, and smartphones. In its most basic configuration, computing system environment 500 typically includes at least one processing unit 502 and computer readable storage medium 504. Depending on the exact configuration and type of computing system environment, computer readable storage medium 504 may be volatile (such as RAM), non-volatile (such as ROM, flash memory, etc.) or some combination of the two. Portions of computer readable storage medium 504 when executed facilitate the determination of device capabilities, the determination of configuration data, and the configuration of devices in order to establish redundant links (e.g., processes 300 and 400).

Additionally, in various embodiments, computing system environment 500 may also have other features/functionality. For example, computing system environment 500 may also include additional storage (removable and/or non-removable) including, but not limited to, magnetic or optical disks or tape. Such additional storage is illustrated by removable storage 508 and non-removable storage 510. Computer storage media includes volatile and nonvolatile, removable and non-removable media implemented in any method or technology for storage of information such as computer readable instructions, data structures, program modules or other data. Computer readable medium 504, removable storage 508 and nonremovable storage 510 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 500. Any such computer storage media may be part of computing system environment 500.

In some embodiments, computing system environment 500 may also contain communications connection(s) 512 that allow it to communicate with other devices. Communications connection(s) 512 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Communications connection(s) 512 may allow computing system environment 500 to communicate over various networks types including, but not limited to, fibre channel, small computer system interface (SCSI), Bluetooth, Zigbee, Z-Wave, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 512 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 500 may also have input device(s) 514 such as keyboard, mouse, a terminal or terminal emulator (either connected or remotely accessible via telnet, SSH, http, SSL, etc.), pen, voice input device, touch input device, remote control, etc. Output device(s) 516 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, computer readable storage medium 504 includes a data type manager module 522, a network resource manager module 524, a data rerouter module 526, and a data cacher module 528. The data type manager module 522 is operable to identify and determine the highest priority type(s) of data to secure according to flow diagrams 300 and 400, for instance. The network resource manager module 524 may be used to determine amounts of available resources (e.g., bandwidth resources, storage resources, etc.) in redundant networks according to flow diagrams 300 and 400, for instance. The data rerouter module 526 operates to select paths through redundant networks to reroute data to a device as described above by reference to FIGS. 1E-1H and flow diagrams 300 and 400, for instance. The data cacher module 528 is operable to identify devices in redundant networks to cache data intended for a receiving device as described above by reference to FIGS. 2A-2C and flow diagrams 300 and 400, for instance.

It is appreciated that implementations according to some embodiments that are described with respect to a computer system are merely exemplary and not intended to limit the scope of the embodiments. For example, some embodiments may be implemented on devices such as switches and routers, which may contain application specific integrated circuits (ASICs), field programmable gate arrays (FPGAs), etc. It is appreciated that these devices may include a computer readable medium for storing instructions for implementing methods according to flow diagrams 300 and 400.

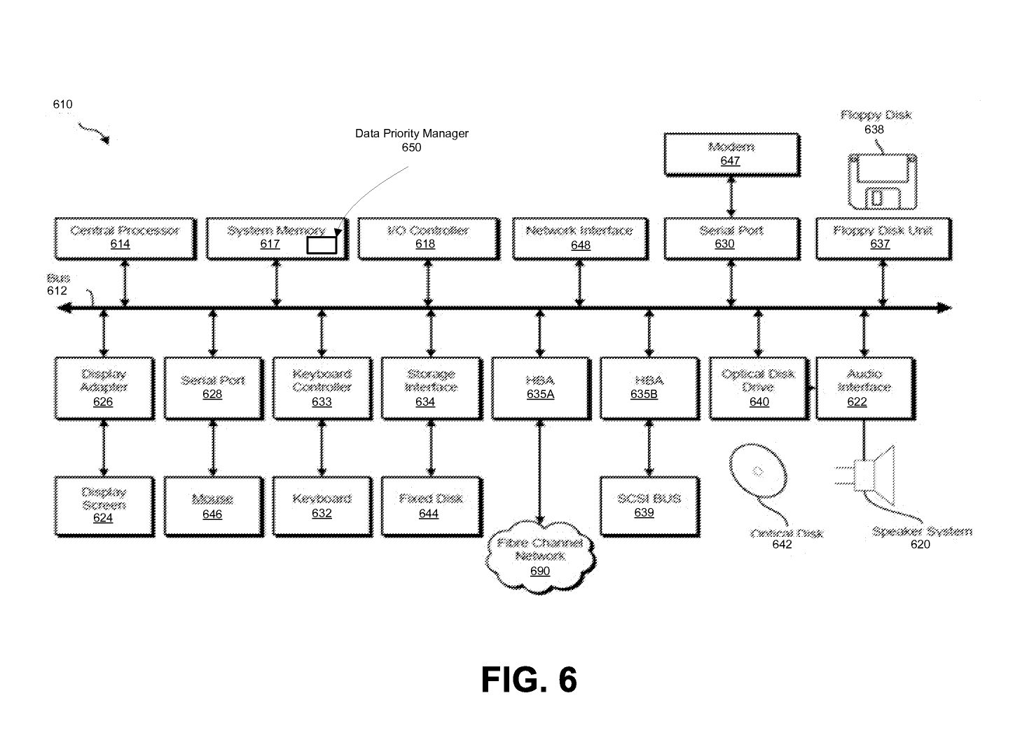

Referring now to FIG. 6, a block diagram of another computer system in accordance with some embodiments is shown. FIG. 6 depicts a block diagram of a computer system 610 suitable for implementing the present disclosure. Computer system 610 includes a bus 612 which interconnects major subsystems of computer system 610, such as a central processor 614, a system memory 617 (typically RAM, but which may also include ROM, flash RAM, or the like), an input/output controller 618, an external audio device, such as a speaker system 620 via an audio output interface 622, an external device, such as a display screen 624 via display adapter 626, serial ports 628 and 630, a keyboard 632 (interfaced with a keyboard controller 633), a storage interface 634, a floppy disk drive 637 operative to receive a floppy disk 638, a host bus adapter (HBA) interface card 635A operative to connect with a Fibre Channel network 690, a host bus adapter (HBA) interface card 635B operative to connect to a SCSI bus 639, and an optical disk drive 640 operative to receive an optical disk 642. Also included are a mouse 646 (or other point-and-click device, coupled to bus 612 via serial port 628), a modem 647 (coupled to bus 612 via serial port 630), and a network interface 648 (coupled directly to bus 612). It is appreciated that the network interface 648 may include one or more Ethernet ports, wireless local area network (WLAN) interfaces, Bluetooth interfaces, Zigbee interfaces, Z-Wave interfaces, etc., but are not limited thereto. System memory 617 includes a data priority manager module 650 which is operable to manage different types of data within the network so that the highest priority type(s) of data are secured when some data may not be retained (e.g., due to a restraint on network resources caused by failure of links and/or devices in the network). According to one embodiment, the data priority manager module 650 may include other modules for carrying out various tasks. For example, the data priority manager module 650 may include the data type manager module 522, the network resource manager module 524, the data rerouter module 526, and the data cacher module 528, as discussed with respect to FIG. 5 above. It is appreciated that the data priority manager module 650 may be located anywhere in the system and is not limited to the system memory 617. As such, residing of the data priority manager module 650 within the system memory 617 is merely exemplary and not intended to limit the scope of the embodiments. For example, parts of the data priority manager module 650 may reside within the central processor 614 and/or the network interface 648 but are not limited thereto.

Bus 612 allows data communication between central processor 614 and system memory 617, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 610 are generally stored on and accessed via a computer readable medium, such as a hard disk drive (e.g., fixed disk 644), an optical drive (e.g., optical drive 640), a floppy disk unit 637, or other storage medium. Additionally, applications can be in the form of electronic signals modulated in accordance with the application and data communication technology when accessed via network modem 647 or interface 648.

Storage interface 634, as with the other storage interfaces of computer system 610, can connect to a standard computer readable medium for storage and/or retrieval of information, such as a fixed disk drive 644. Fixed disk drive 644 may be a part of computer system 610 or may be separate and accessed through other interface systems. Network interface 648 may provide multiple connections to other devices. Furthermore, modem 647 may provide a direct connection to a remote server via a telephone link or to the Internet via an internet service provider (ISP). Network interface 648 may provide one or more connection to a data network, which may include any number of networked devices. It is appreciated that the connections via the network interface 648 may be via a direct connection to a remote server via a direct network link to the Internet via a POP (point of presence). Network interface 648 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 6 need not be present to practice the present disclosure. The devices and subsystems can be interconnected in different ways from that shown in FIG. 6. The operation of a computer system such as that shown in FIG. 6 is readily known in the art and is not discussed in detail in this application. Code to implement the present disclosure can be stored in computer-readable storage media such as one or more of system memory 617, fixed disk 644, optical disk 642, or floppy disk 638. The operating system provided on computer system 610 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments disclosed. Many modifications and variations are possible in view of the above teachings.

What is claimed is:

1. A system comprising:
a plurality of devices forming a communication network, wherein the plurality of devices is networked via their respective primary link, wherein the plurality of devices is configured to revert to a redundant network upon a primary link associated with a first device in the plurality of devices failing; and
a second device in the plurality of devices configured to transmit a plurality of different types of data having different priorities to the first device through the primary link associated with the first device when the primary link associated with the first device is operational, wherein the second device is further configured to reroute a subset of the plurality of different types of data based on the priorities of the plurality of different types of data through the redundant network in response to the primary link associated with the first device failing.

2. The system as described in claim 1, wherein the second device is further configured to determine an amount of available bandwidth in the redundant network for rerouting the plurality of different types of data to the first device, wherein the second device is further configured to determine the subset of the plurality of different types of data based on the determined amount of available bandwidth.

3. The system as described in claim 2, wherein the second device determines the amount of available bandwidth based on bandwidth capabilities and bandwidth utilization of links in the redundant network.

4. The system as described in claim 1, wherein the second device is further configured to reroute a different subset of the plurality of different types of data having higher priorities through the redundant network in response a change in the amount of available bandwidth in the redundant network.

5. The system as described in claim 1, wherein the primary link associated with the second device is associated with a first communication interface, wherein the secondary link associated with the second device is associated with a second communication interface, wherein the first communication interface differs from the second communication interface.

6. The system as described in claim 5, wherein the first communication interface is based on a wired link, and wherein the second communication interface is based on a wireless link.

7. The system as described in claim 6, wherein the second communication interface is a radio frequency (RF) interface.

8. The system as described in claim 6, wherein the second communication interface is one of a Bluetooth interface, a White-Fi interface, Ultra Wide Band (UWB) interface, and Wi-Fi interface.

9. A system comprising:
a plurality of devices forming a communication network, wherein the plurality of devices is networked via their respective primary link, wherein devices in the plurality of devices are configured to revert to a redundant network upon a primary link associated with a first device in the plurality of devices failing; and
a second device in the plurality of devices configured to send a plurality of different types of data having different priorities to the first device through the communication network, wherein the second device is further configured to cause a set of devices in the plurality of devices to cache a subset of the plurality of different types of data destined for the first device, based on the priorities of the plurality of different types of data, in response to the primary link associated with the first device failing and further in absence of an alternative path from the second device to the first device.

10. The system as described in claim 9, wherein the second device is further configured to determine an amount of available storage in the communication network for caching the plurality of different types of data, and wherein the second device is further configured to determine the subset of the plurality of different types of data destined for the first device based on the determined amount of available storage.

11. The system as described in claim 10, wherein the second device determines the amount of available storage based on storage capabilities and storage utilization of devices in the plurality of devices.

12. The system as described in claim 9, wherein the second device is further configured to dynamically change the set of devices based on changes in the amount of available storage in the communication network.

13. The system as described in claim 9, wherein the second device is further configured to cause at least one device in the set of devices to cache a type of data in the subset of the plurality of different types of data in place of a type of data having a lower priority.

14. A system comprising:
a plurality of devices forming a communication network, wherein the plurality of devices is networked via their respective primary link, wherein devices in the plurality of devices are configured to revert to a redundant network upon a primary link associated with a first device in the plurality of devices failing; and
a second device in the plurality of devices configured to transmit a plurality of different types of data having different priorities to the first device through the primary link associated with the first device when the primary link associated with the first device is operational, wherein the second device is further configured to reroute a first subset of the plurality of different types of data based on priorities of the plurality of different types of data through a redundant link associated with the first device in response to the primary link associated with the first device failing and further in response to existence of a path from the first device to the second device, and wherein the second device is further configured to cause a set of devices in the plurality of devices to cache a second subset of the plurality of different types of data destined for the first device, based on priorities of the plurality of different types of data, in response to the primary link associated with the first device failing and further in absence of the path from the second device to the first device.

15. The system as described in claim 14, wherein the second device is further configured to cause the set of devices to transmit the cached data to the first device upon detecting that the primary link is functional again subsequent to the primary link associated with the first device failing.

16. The system as described in claim 14, wherein the second device and devices in the plurality of devices form a redundant network in response to the primary link associated with the first device failing, wherein the second device is further configured to use a plurality of different communication interfaces to reroute the first subset of the plurality of different types of data having higher priorities through the redundant network.

17. The system as described in claim 16, wherein the plurality of different communication interfaces comprises a wired interface and a wireless interface.

18. The system as described in claim 17, wherein the wireless interface is a radio frequency (RF) interface.

19. The system as described in claim 17, wherein the wireless interface is one of a Bluetooth interface, a White-Fi interface, Ultra Wide Band (UWB) interface, and Wi-Fi interface.

20. The system as described in claim 17, wherein the wired interface is an Ethernet interface.
